(19) United States
(12) Patent Application Publication
(10) Pub. No.: US 2016/0252334 A1
(43) Pub. Date: Sep. 1, 2016

(54) SUPERSONIC PROJECTILE NOSE CONES WITH FLAT TIPS

(71) Applicant: The Boeing Company, Chicago, IL (US)

(72) Inventors: Andrew W. Cary, St. Charles, MO (US); Andrew J. Dorgan, Edwardsville, IL (US)

(73) Assignee: The Boeing Company, Chicago, IL (US)

(21) Appl. No.: 14/218,069

(22) Filed: Mar. 18, 2014

(51) Int. Cl. F42B 10/46; B64C 1/00; B64C 30/00

(52) U.S. Cl. CPC F42B 10/46; B64C 30/00; B64C 1/0009

(57) ABSTRACT

Supersonic projectile nose cones with flat tips are disclosed. An example apparatus includes a nose cone for a projectile configured for supersonic flight at velocities of at least Mach 2.0. The nose cone has an axisymmetric body extending from a base to a tip. The body has a thickness and defines an interior cavity. The tip is defined by a flat face normal to a central axis of the projectile.

### FIELD OF THE DISCLOSURE

This disclosure relates generally to projectile nose cones and, more particularly, to supersonic projectile nose cones with flat tips.

### BACKGROUND

A nose cone is the forwardmost section of an object (e.g., a projectile such as a missile, rocket, aircraft or bullet) meant to travel through a compressible fluid medium (e.g., air or water). Nose cone shapes (e.g., geometry) are typically carefully designed to minimize aerodynamic drag while meeting geometric constraints.

Nose cone aerodynamic drag includes skin friction drag and pressure drag. Skin friction drag is largely dependent on wetted area, which is an area of the object in contact with external fluid flow (e.g., airflow). Pressure drag is caused by air that is compressed by movement of the object through the fluid.

The ratio of nose cone length to base diameter (e.g., L/D) is known as a fineness ratio. At supersonic speeds, the fineness ratio has a significant effect on nose cone pressure drag, particularly at low ratios (e.g., for nose cones with relatively short lengths and large base diameters). As the fineness ratio increases, the wetted area also increases due to the increased length relative to base diameter and results in additional skin friction drag. Therefore, nose cones are designed to minimize drag for various speeds and fineness ratios, which ultimately involves tradeoffs between pressure drag and skin friction drag.

Classical solutions have identified theoretically optimum nose cone shapes for particular applications. However, such classical solutions may not satisfy geometric constraints required by certain applications.

### SUMMARY

An example apparatus includes a nose cone for a projectile configured for supersonic flight at velocities of at least Mach 2.0. The nose cone has an axisymmetric body extending from a base to a tip. The body has a thickness and defines an interior cavity. The tip is defined by a flat face normal to a central axis of the projectile.

Another example apparatus includes a nose cone for a projectile configured for supersonic flight at velocities of at least Mach 2.0, where the nose cone has an axisymmetric body extending from a base to a tip and where the tip is defined by a flat face normal to a central axis of the nose cone. The nose cone has a length defined by the distance between the base and the tip along the central axis of the projectile and the base has a base diameter. A ratio of the length to the base diameter is to be greater than 2.

The features, functions, and advantages that have been discussed can be achieved independently in various examples or may be combined in yet other examples further details of which can be seen with reference to the following description and drawings.

### BRIEF DESCRIPTION OF THE DRAWINGS

FIG. 1 illustrates a nose cone profile having a known shape.

FIG. 2A illustrates an example nose cone profile having a flat face.

FIG. 2B is a detail view of the example nose cone profile of FIG. 2A.

FIG. 3 illustrates optimum ratios of tip diameter to base diameter for example nose cone profiles having flat faces.

FIG. 4A illustrates example flat face nose cone profiles for various intended velocities on a linear scale.

FIG. 4B illustrates example flat face nose cone profiles for various intended velocities on a logarithmic scale.

FIG. 4C illustrates an example flat face nose cone profile optimized for a velocity of Mach 3.5 compared to example flat face nose cone profiles optimized for other velocities.

FIG. 4D illustrates an LV-Haack nose cone profile compared to example flat face nose cone profiles optimized for various velocities.

Wherever appropriate, the same reference numbers will be used throughout the drawing(s) and accompanying written description to refer to the same or like parts.

### DETAILED DESCRIPTION

A nose cone is the forwardmost section of an object (e.g., a projectile such as a missile, rocket, aircraft or bullet) meant to travel through a compressible fluid medium (e.g., air or water). The magnitude of nose cone drag in relation to total drag is a function of nose cone geometry and the speed (e.g., Mach number) of the object travelling through the fluid. In general, for objects traveling at speeds below Mach 0.8, nose cone pressure drag is negligible for most shapes. The most significant drag factor is skin friction drag, which is largely dependent on wetted area (i.e., the surface area of the object in contact with fluid flow). For objects traveling at supersonic speeds (i.e., speeds greater than Mach 1) and hypersonic speeds (i.e., speeds greater than Mach 5), nose cone pressure drag can be a significant percentage of overall drag. The major factors that influence nose cone pressure drag include speed, nose cone shape and fineness ratio (i.e., the ratio of nose cone length to its base diameter). As used herein, nose cone length refers to a distance between a base and a tip of a nose cone, measured along its central axis.

In general, it is desirable to minimize nose cone drag for objects such as projectiles to minimize fuel requirements, which in turn enables increased range and/or speed. Extensive theoretical analysis has taught that optimal nose cone shapes have sharp noses when length is unconstrained. However, practical applications rarely lack geometric constraints. To that end, classical solutions such as the power-law series, the LV-Haack series, and the LD-Haack series (e.g., the von Karman Ogive), among others quantify optimal nose cone shapes for certain constraints. For example, the power-law series provides optimal shapes for a given bluntness, the LV-Haack series provides optimal shapes for a given length and volume, and the LD-Haack series provides optimal shapes for a given length and diameter.

However, the constraints addressed by such classical solutions may not meet all of the geometric constraints specified by certain applications. For example, geometric constraints such as length, nose cone diameter, intermediate diameters, internal volume, and/or tip radius of curvature, among others, may be specified. Such geometric constraints may be specified to accommodate items such as electronics (e.g., guidance hardware) housed inside the nose cone. In such examples, nose cone shapes must depart from the classical solutions to conform to geometric constraints, but still must be designed to minimize drag. Conventionally, such nose cones utilize hemispherical and/or blunt nose cones. Such nose shapes often result from either payload or manufacturing constraints.

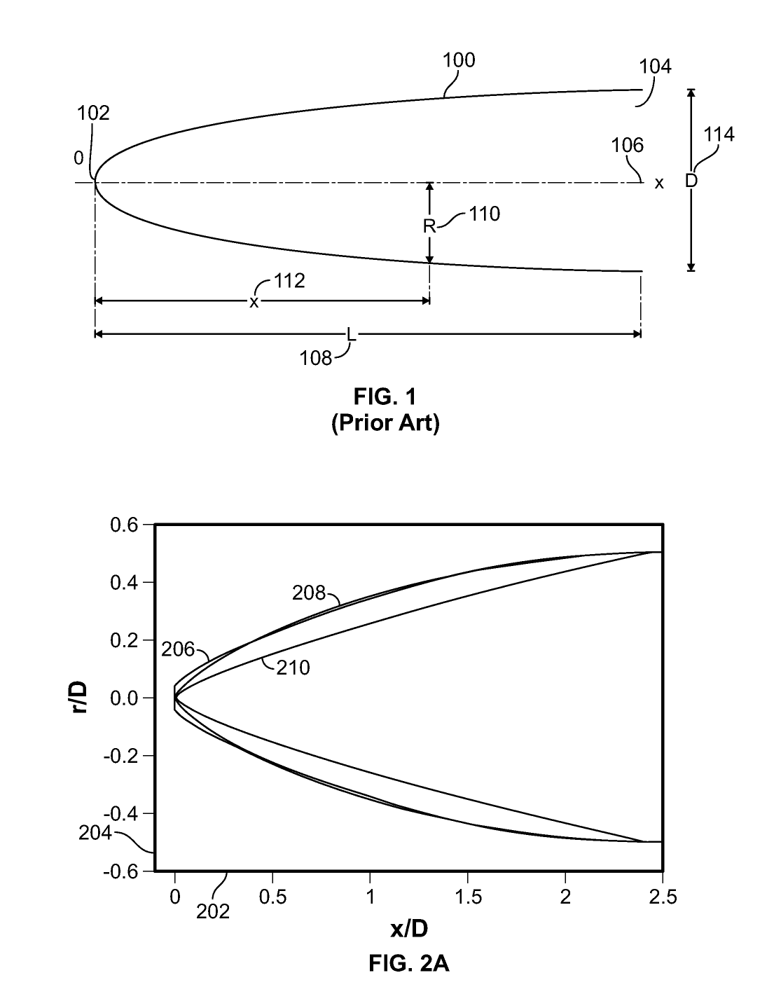

FIG. 1 illustrates a nose cone 100 having a known shape. The nose cone 100 has a tip 102 and a base 104. The distance between the tip 102 and the base 104 along a central axis 106 of the nose cone 100 defines a length L 108. The nose cone 100 is a solid of revolution about the central axis 106 and has a radius r 110. The radius r 110 increases as the distance x 112 from the tip 102 to the base 104 increases, ultimately reaching a base diameter D 114 (i.e., twice the radius r) at the base 104, when the position x 112 equals the length L. The terminology used to describe the nose cone 100 will be similarly used to describe other nose cones.

Example apparatus disclosed herein include a projectile nose cone having an axisymmetric body extending from a base to a tip. The nose cone body has a thickness and defines an interior cavity. The tip is defined by a flat face normal to the central axis of the nose cone. Such example apparatus provide superior performance over known nose cone apparatus in terms of aerodynamics (e.g., drag), ability to meet geometric constraints, thermal performance, radar capabilities and manufacturing, among other factors.

The example nose cone apparatus having a flat face as disclosed herein minimizes drag by optimizing the balance of pressure drag and skin friction drag. The flat face of the tip of the nose cone disclosed herein is the result of a trade-off between increased pressure drag at the tip of the nose cone due to its flat face and lower pressure drag over the remainder of the nose cone due to shallowing of (e.g., decreasing) the slope of the nose cone wall. Theoretically, a minimal drag shape is obtained by lengthening the nose and, thus, shallowing the slope of the nose cone wall until reductions in pressure drag due to increased length are balanced by increases in skin friction drag due to increased wetted area. For nose cones that are constrained in length, increases in pressure drag at the tip due to the flat face relative to nose cones having pointed or rounded tips are outweighed by decreases in pressure drag due to the nose cone walls having a shallower slope than nose cones having pointed or rounded tips. Thus, the nose cone apparatus having a flat face as disclosed herein provides superior aerodynamic drag performance over known nose cone apparatus in certain applications.

In addition to superior aerodynamic drag performance, the flat face nose cone apparatus disclosed herein provides additional advantages over known nose cone apparatus. For example, the flat face nose cone apparatus disclosed herein may be tailored to provide larger intermediate diameters of the nose cone relative to known nose cones, which in turn provides larger internal volumes relative to known nose cones for given fineness ratios. Accordingly, the flat face nose cone apparatus disclosed herein can meet many geometric constraints, such as intermediate diameters and tip radius of curvature, for example, that known nose cone apparatus cannot meet, in addition to providing superior aerodynamic drag performance.

The example nose cone apparatus having a flat face as disclosed herein provides superior aerodynamic drag performance for many, but not all, projectile applications. Whether the nose cone apparatus having a flat face is suitable for a particular application depends on, among other factors, (1) whether drag is an important figure of merit; (2) whether the projectile to which the nose cone is attached is in the proper flight domain (e.g., Mach number and fineness ratio); and/or (3) whether the resulting nose cone diameter is feasible given manufacturing tolerances.

The example nose cone apparatus having a flat face as disclosed herein is suitable for objects in which drag is an important figure of merit. For example, drag may not be a critical design factor for certain types of ammunition, such as ammunition for firearms such as handguns, rifles and shoulder-launched weapons. For these applications, nose cone apparatus may be dictated by other factors, such as impact characteristics (e.g., hollow point ammunition). Furthermore, these applications are manually aimed. Because accuracy decreases with range, drag effects at long ranges may be outweighed by operator accuracy variability. Thus, the nose cone apparatus having a flat face is not suitable for small projectiles, such as ammunition for firearms such as handguns, rifles and shoulder-launched weapons.

The example nose cone apparatus having a flat face as disclosed herein is suitable for projectiles in a given flight domain (e.g., Mach number and fineness ratio). As mentioned above, the magnitude of nose cone drag in relation to total drag is a function of nose cone geometry and the velocity (e.g., Mach number) of the object travelling through the fluid. In general, nose cone pressure drag is negligible for objects traveling at low velocities (below Mach 0.8). It is found that nose cone apparatus having a flat face as disclosed herein provide appreciable performance results at velocities at or above Mach 2.0. In addition, fineness ratio (e.g., L/D) is an important consideration. It is found that nose cone apparatus having a flat face as disclosed herein provide appreciable performance results at fineness ratios greater than 2.0. For example, the nose cone apparatus having a flat face as disclosed herein is beneficial for many projectiles having a fineness ratio between about 2.0 and 5.0. However, it is found that nose cone apparatus having a flat face as disclosed herein would not have appreciable effects on aerodynamic drag for objects having low fineness ratios (e.g., L/D of 2 or less).

The example nose cone apparatus having a flat face as disclosed herein is suitable for objects in which the optimum nose cone apparatus is feasible to manufacture, given manufacturing constraints. For example, certain projectiles (e.g., armor piercing tank rounds) may benefit from nose cone apparatus having a flat face. However, because of the relatively small size of such projectiles, a flat face of a nose cone would be too small to manufacture (e.g., mill or form) at appropriate costs relative to potential drag benefits.

Thus, the example nose cone apparatus having a flat face as disclosed herein is suitable for many but not all applications. Example applications include but are not limited to, for example, air-to-air missiles (e.g., AIM-9); surface-to-air missiles (e.g., S-75); supersonic cruise missiles (e.g., Brahmos); intercontinental ballistic missiles (“ICBMs,” e.g., Minuteman III); multiple independently targetable reentry vehicles (“MIRVs,” e.g., ICBM-launched MIRVs); rail gun projectiles; air-to-ground missiles (e.g., HARM), space-launched rockets (e.g., Delta IV); and/or any other supersonic object (e.g., projectile and/or vehicle) in the suitable flight domain, as described above.

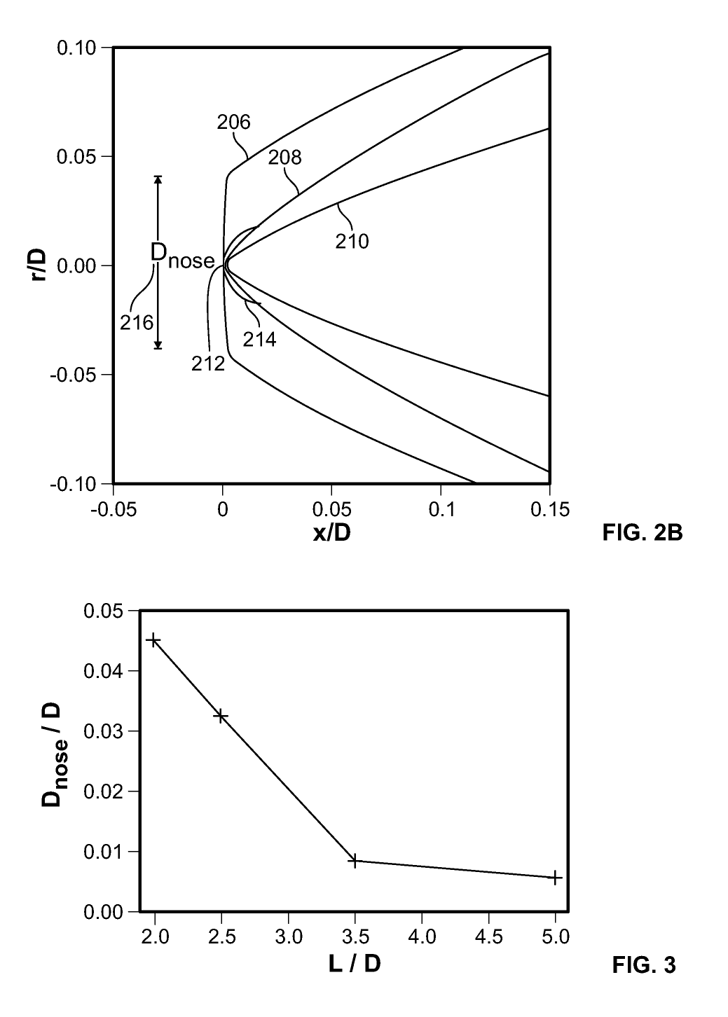

Turning to FIG. 2A, nose cone shape profiles for various nose cone apparatus are illustrated. In FIG. 2A, an abscissa axis 202 represents non-dimensionalized nose cone position and, more specifically, nose cone position x divided by nose cone base diameter D. An ordinate axis 204 represents non-dimensionalized nose cone radius r and, more specifically, nose cone radius r divided by the base diameter D.

FIG. 2A illustrates a flat face nose cone profile 206 in accordance with the present disclosure. The flat face nose cone profile 206 is designed to provide minimum drag for objects intended to travel at velocities near Mach 3.5. However, other examples according to the present disclosure provide minimum drag for objects intended to travel velocities of Mach 2.0 or greater. FIG. 2A also includes nose cone shapes corresponding to an LV-Haack profile 208 and a hypersonic optimum profile 210. The LV-Haack profile 208 and the hypersonic optimum profiles 210 are examples of classical nose cone shapes.

The LV-Haack profile 208 is generated from the Haack series, which is mathematically defined by:

$$\begin{matrix}θ ( x ) = arccos ( 1 - \frac{2 x}{L} ) & ( 1 ) \\ r ( θ ) = \frac{R}{\sqrt{x}} \sqrt{( θ - \frac{sin ( 2 θ )}{2} ) + C {sin}^{3} θ} & ( 2 )\end{matrix}$$

where L is the length of the nose cone, x is a position on the nose cone, r is the radius of the nose cone, R is the radius at the base of the nose cone (i.e., D/2 at x=L), and C is a coefficient specifying particular shapes of the Haack family. The particular LV-Haack profile 208 of FIG. 2A is defined by C=⅓.

The hypersonic optimum profile 210 is generated from the power-law series of shapes, which is mathematically defined by:

$$r ( x ) = {R ( \frac{x}{L} )}^{n} \qquad ( 3 )$$

where r is the radius of the nose cone, x is a position on the nose cone, R is the radius at the base of the nose cone (i.e., D/2 at x=L), L is the length of the nose cone, and n is a coefficient specifying bluntness of the nose cone. The hypersonic optimum profile 210 (e.g., the Newtonian hypersonic optimum) is defined by n=0.75.

FIG. 2B is a detail view of the nose cone shape profiles 206, 208 and 210 of FIG. 2A. As shown in FIG. 2B, the flat face nose cone profile 206 has a tip 212 defining a completely flat face, whereas the LV-Haack profile 208 and the hypersonic optimum profile 210 have rounded or pointed tips. FIG. 2B also includes an example radius of curvature 214. In certain applications, a minimum radius of curvature, such as the radius of curvature 214, is an example of a geometrical constraint that may be specified for particular applications. As shown in FIG. 2B, LV-Haack profile 208 and the hypersonic optimum profile 210 do not satisfy the example radius of curvature 214 constraint. However, the flat face nose cone profile 206 meets the radius of curvature 214 constraint.

The flat face nose cone profile 206 has a tip diameter Dₙₒₛₑ 216, which is the diameter of the flat portion of the tip 212 of the flat face nose cone profile 206. The size of the tip diameter Dₙₒₛₑ 216 depends on numerous factors, such as fineness ratio and intended velocity (e.g., Mach number), among other factors.

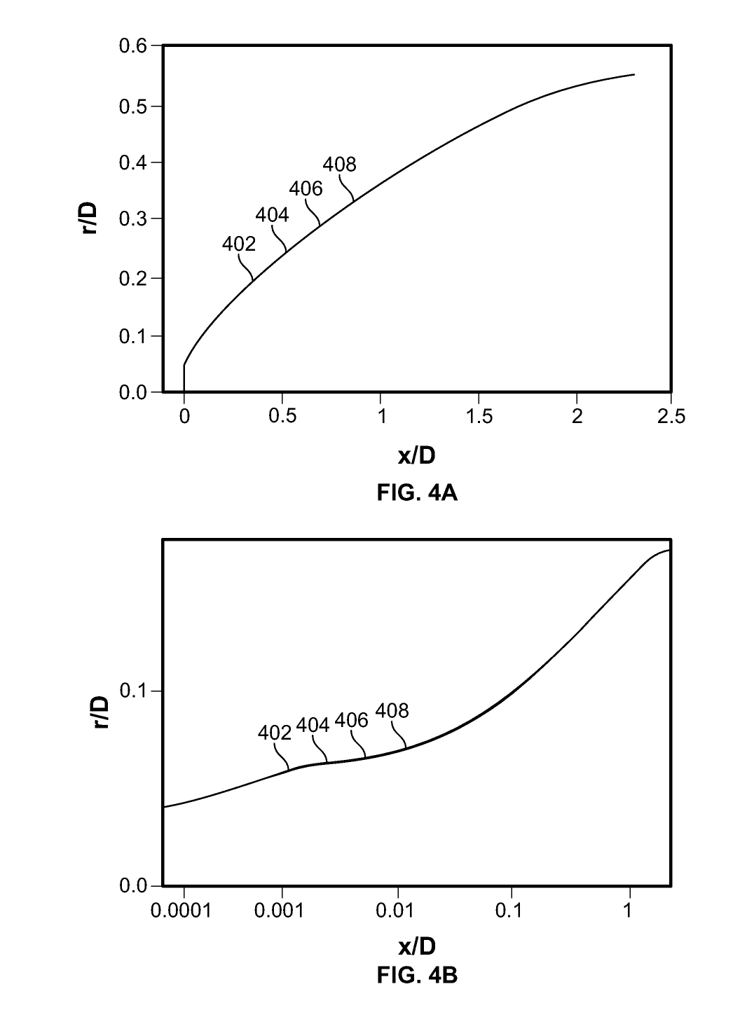

FIG. 3 illustrates example optimum ratios of tip diameter Dₙₒₛₑ (e.g., the tip diameter Dₙₒₛₑ 216 of FIG. 2B) to base diameter (e.g., the base diameter D 114 of FIG. 1) for a flat face nose cone profile (e.g., the flat face nose cone profile 206 of FIG. 2B) at various fineness ratios (e.g., L/D), which are listed in TABLE 1 below. As shown in FIG. 3 and in TABLE 1, Dₙₒₛₑ/D decreases as L/D (e.g., fineness ratio) increases. In other words, as the length L of a nose cone increases relative to its base diameter D, the optimum flat face tip diameter Dₙₒₛₑ decreases.

TABLE 1

| L/D | Dₙₒₛₑ/D |
|---|---|
| 2.0 | 0.0450 |
| 2.5 | 0.0325 |
| 3.5 | 0.0086 |
| 5.0 | 0.0056 |

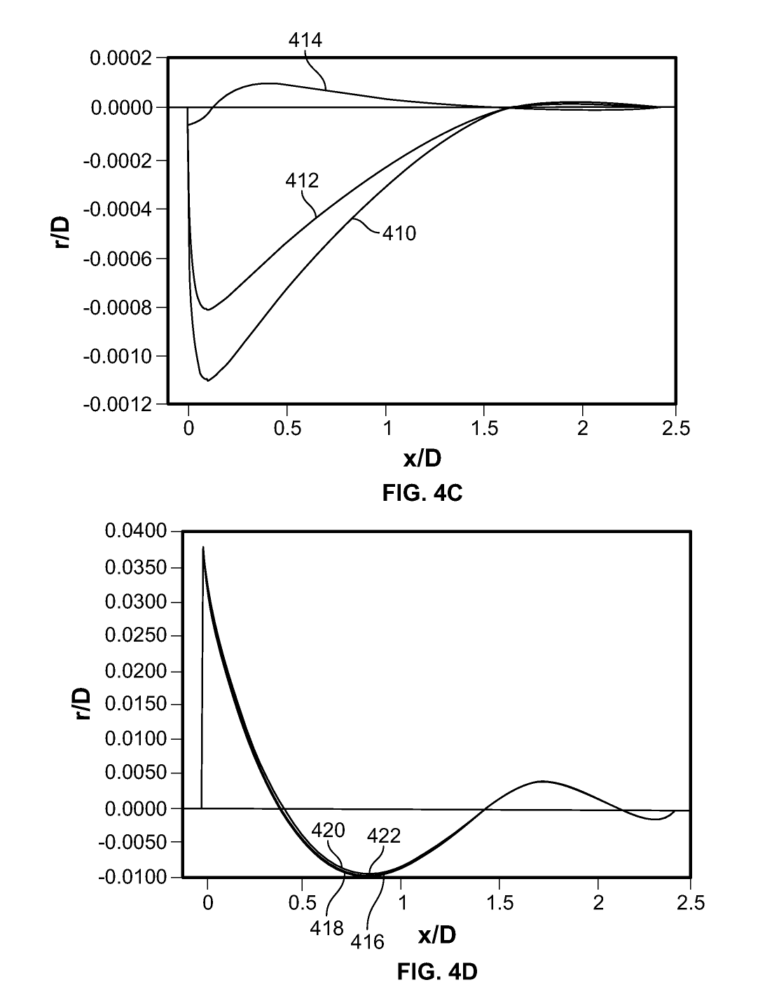

Turning to FIGS. 4A and 4B, example flat face nose cone profiles designed to provide minimum drag for various intended velocities (e.g., Mach numbers) are illustrated. Notably, such example flat face nose cone profiles are virtually indistinguishable.

The example flat face nose cone profile 206 of FIGS. 2A and 2B is designed to provide minimum drag for objects intended to travel at a particular velocity, namely, near Mach 3.5. As illustrated in FIGS. 4A and 4B, example flat face nose cone profiles are designed to provide minimum drag for objects intended to travel at various velocities, including a Mach 2.5 profile 402, a Mach 3.0 profile 404, a first Mach 3.5 profile 406 and a second Mach 3.5 profile 408. The Mach 2.5 profile 402, the Mach 3.0 profile 404 and the first Mach 3.5 profile 406 are designed for an angle of attack of zero degrees, whereas the second Mach 3.5 profile 408 is designed for an angle of attack of 5 degrees. FIG. 4A illustrates the flat face nose cone profiles on a linear scale, whereas FIG. 4B illustrates the flat face nose cone profiles on a logarithmic scale. As shown in FIGS. 4A and 4B, the flat face nose cone profiles 402, 404, 406 and 408 overlie substantially the same slope and, thus, are virtually indistinguishable. Thus, the flat face nose cone profile design is robust at various intended velocities and angles of attack.

FIG. 4C illustrates the example first Mach 3.5 profile 406 compared to each of the example Mach 2.5 profile 402, the Mach 3.0 profile 404, and the second Mach 3.5 profile 408. More specifically, a line 410 represents the difference between the first Mach 3.5 profile 406 and the Mach 2.5 profile 402; a line 412 represents the difference between the first Mach 3.5 profile 406 and the Mach 3.0 profile 404; and a line 414 represents the difference between the first Mach 3.5 profile 406 and the second Mach 3.5 profile 408. Although there is a noticeable difference between the lines 410, 412 and 414, the overall non-dimensionalized nose cone radius scale is relatively small. Thus, differences in optimal flat face nose cone profiles for various intended velocities and angles of attack exist; however, those differences are relatively small.

FIG. 4D illustrates the LV-Haack nose cone profiles (e.g., the LV-Haack nose cone profile 208 of FIGS. 2A and 2B) compared to each of the example Mach 2.5 profile 402, the Mach 3.0 profile 404, the first Mach 3.5 profile 406, and the second Mach 3.5 profile 408. More specifically, line 416 represents the difference between the LV-Haack nose cone profile 208 and the Mach 2.5 profile 402; line 418 represents the difference between the LV-Haack nose cone profile 208 and the Mach 3.0 profile 404; line 420 represents the difference between the LV-Haack nose cone profile 208 and the first Mach 3.5 profile 406; and line 422 represents the difference between the LV-Haack nose cone profile 208 and the second Mach 3.5 profile 408. As shown in FIG. 4D, lines 416, 418, 420 and 422 have the greatest values at x/D=0. In other words, the largest difference between the LV-Haack nose cone profile 208 and each of the example profiles 402, 404, 406 and 408 exists at the tip of the nose cone (e.g., x/D=0). This is expected because the LV-Haack nose cone profile 208 has a rounded tip, whereas each of the profiles 402, 404, 406 and 408 has a flat tip. In addition, the profiles 402, 404, 406 and 408 are thinner than the LV-Haack nose cone profile 208 from approximately x/D=0.4 to 1.4 and thicker from approximately x/D=1.4 to 2.2. Furthermore, the profiles 402, 404, 406 and 408 converge towards the LV-Haack nose cone profile 208 at further distances of x/D.

From the foregoing, it will be appreciated that the above disclosed apparatus utilize nose cone geometries including a flat face. Such nose cone geometries provide superior performance over known nose cone apparatus in terms of aerodynamics (e.g., drag), ability to meet geometric constraints, thermal performance, radar capabilities and manufacturing costs, among other factors.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus, comprising:
a nose cone for a projectile configured for supersonic flight at velocities of at least Mach 2.0, the nose cone having an axisymmetric body extending from a base to a tip, the body having a thickness and defining an interior cavity, and the tip being defined by a flat face normal to a central axis of the nose cone.

2. The apparatus as defined in claim 1, wherein the nose cone has a length defined by the distance between the base and the tip along the central axis of the projectile, and the base has a base diameter, the ratio of the length to the base diameter defining a fineness ratio.

3. The apparatus as defined in claim 2, wherein the fineness ratio is greater than 2.

4. The apparatus as defined in claim 2, wherein the fineness ratio is between about 2 and 5.

5. The apparatus as defined in claim 2, wherein the flat face of the tip has a tip diameter that is 0.5-5 percent of the base diameter.

6. The apparatus as defined in claim 1, wherein the projectile is configured for supersonic flight at velocities of about Mach 2.0 to Mach 3.5.

7. The apparatus as defined in claim 1, wherein the projectile is configured for supersonic flight at velocities above Mach 3.5.

8. The apparatus as defined in claim 1, wherein the projectile is configured for supersonic flight at velocities above Mach 7.0.

9. The apparatus as defined in claim 1, wherein the projectile is a surface-to-air missile.

10. The apparatus as defined in claim 1, wherein the projectile is an air-to-air missile.

11. The apparatus as defined in claim 1, wherein the projectile is a rocket for access to space.

12. An apparatus, comprising:
a nose cone for a projectile configured for supersonic flight at velocities of at least Mach 2.0, the nose cone having an axisymmetric body extending from a base to a tip, the tip being defined by a flat face normal to a central axis of the nose cone,
wherein the nose cone has a length defined by the distance between the base and the tip along the central axis of the projectile, and
wherein the base has a base diameter, a ratio of the length to the base diameter to be greater than 2.

13. The apparatus as defined in claim 12, wherein the ratio is between 2 and 5.

14. The apparatus as defined in claim 12, wherein the flat face of the tip has a tip diameter that is 0.5-5 percent of the base diameter.

15. The apparatus as defined in claim 12, wherein the projectile is configured for supersonic flight at velocities of about Mach 2.0 to Mach 3.5.

16. The apparatus as defined in claim 12, wherein the projectile is configured for supersonic flight at velocities above Mach 3.5.
